(19) United States
(12) Patent Application Publication
(10) Pub. No.: US 2010/0309659 A1
(43) Pub. Date: Dec. 9, 2010

(54) DRYING LIGHT SOURCE

(75) Inventor: Reinhard Jenny, Schlieren (CH)

Correspondence Address: THE NATH LAW GROUP, 112 South West Street, Alexandria, VA, 22314, US

(73) Assignee: VOLPI AG, Schlieren (CH)

(21) Appl. No.: 12/796,350

(22) Filed: Jun. 8, 2010

(30) Foreign Application Priority Data
Jun. 9, 2009 (CH) 00910/09

(51) Int. Cl. F21S 19/00; F21V 9/00

(52) U.S. Cl. 362/228; 362/231

(57) ABSTRACT

A drying light source (1), in which the light of a number of single light sources (3) is applied heterodyned and bundled to an object level (5) with the help of optical elements (6, 4, 7, 8).

The present invention relates to a drying light source according to the generic term of Claim 1.

Such light sources are preferably used in multi-color printing machines, as they are described in DE 44 42 557 (Heidelberger). These multi-color printing machines, as they are also known from DE 102 25 198, transport and transfer wet partial frames, which are fed to a drying station subsequent to an ink transfer process. These drying stations can, depending on the consistency of the printing ink, have a hot air blower, an electron irradiator according to DE 10 2007 048 282, or a UV dryer with UV light emitting diode arrays as is known, for example, from DE 10 2007 028 403.

UV-drying printing inks or lacquers consist of substances that are capable of flowing and include, for example, monomers, oligomers and/or other photo initiators, which crosslink into a dry film subject to the effect of an energy-rich UV irradiation. Today, these substances are quickly becoming more important because these can also be used for printing onto materials that are not very absorbent. The hardening speed, i.e. the degree of hardening is, for example, dependent upon the design and power of the UV irradiators, the machine speed, the materials that are to be printed and/or the composition of the ink.

The UV hardening process—sometimes also simply called UV drying, can be used in almost all areas of the printing industry, especially there, where fast drying of the printing ink and/or lacquers is desired for fast further processing. Thus, the method is suitable not only for the accelerated printing of paper and/or carton for the production of high-gloss prospectuses or high-gloss packaging, but also for the printing of plastic material and for tin printing.

But for some applications it is advantageous to perform UV drying with different wave lengths, for example, in order to first only touch-dry a printing ink and to then thoroughly harden its entire volume or to activate different photo initiators. Suitable ink hardening devices include a drying light source, in the following also called multi-wavelength light source, as it is described, for example, in DE 10 2004 015 700. The light emitting diodes (LEDs) used in this drying light source are configured in rows and do not only have different wave lengths, but can also be switched on separately, in order to, if necessary, use individual wave lengths separately.

The LED drying light sources constructed in this way are sensitive to temperature changes and require, because of their design (closely adjacent high power LEDs), expensive cooling means. Beyond that, these drying light sources must be mounted very close to the object to be illuminated because of the large aperture emission characteristic of the high power LEDs. This leads to extremely narrow spatial relationships, which severely limits the variability for the design of the drying light source and thus the possibilities of application and use of such in different printing machines.

For this reason, it is the objective of the present invention to provide a drying light source with which the known disadvantages of the known drying light source can be overcome. In particular, no expensive and/or interference-prone cooling means are to be required and the spatial relationships are to allow a simplified coordination with the special use of the drying light source in different printing machines.

In accordance with the invention, this objective is solved by a drying light source with the characteristics of Claim 1, and in particular, by a multi-wavelengths overall light source with an optical unit for heterodyning different beam bundles. Advantageously, this multi-wavelength overall light source comprises at least one first individual light source and a second individual light source, whereby their emitted light respectively has a dominant wave length (λ₁, and/or λ₂) and optical means are provided for heterodyning the emitted light of these individual light sources.

A preferred embodiment of the drying light source in accordance with the invention differentiates it self thereby, that the optical means comprise at least one reflector and/or at least one beam divider, whereby the reflector is mounted and designed in such a way that at least the emitted light (λ₁) of the first individual light source is reflected and strikes heterodyned with the emitted light (λ₂) of the second individual light source onto the object field that is to be illuminated, and whereby the beam divider is mounted and designed in such a way that the emitted light (λ₁) of the first individual light source is reflected onto the object field that is to be illuminated and the emitted light (λ₂) of the second individual light source can pass unhindered in order to heterodyne itself with the emitted light (λ₁) of the first individual light source.

For the individual single light sources of the drying light source in accordance with the invention, high power LEDs (LS1, LS2, LS3) with large aperture emission, halogen beamers or gas discharge lamps have shown to be particularly suitable. Thereby, it was shown to be advantageous when the individual single light sources (LS1, LS2, LS3) are provided with condenser optics (CO1, CO2, CO3) and/or a collector is provided between the beam dividers and the object to be illuminated.

In a further embodiment of the drying light source in accordance with the invention, optic characteristics for the homogenization of the total light that is striking the object field to be illuminated are provided between the beam dividers and the object field to be illuminated.

Advantageously, the optical means for heterodyning the emitted light comprise cylindrical and/or spherical optical elements.

In a preferred embodiment, the drying light source in accordance with the invention differentiates itself thereby, that at least one of the individual single light sources comprises an illumination arrangement with an LED array of m×n LEDs. Thereby, the LED array can have a number of similar or different LEDs and/or the illumination unit can have several LED arrays.

In the following, the invention will be explained in more detail using individual examples of embodiments, and in conjunction with the figures.

Shown are:

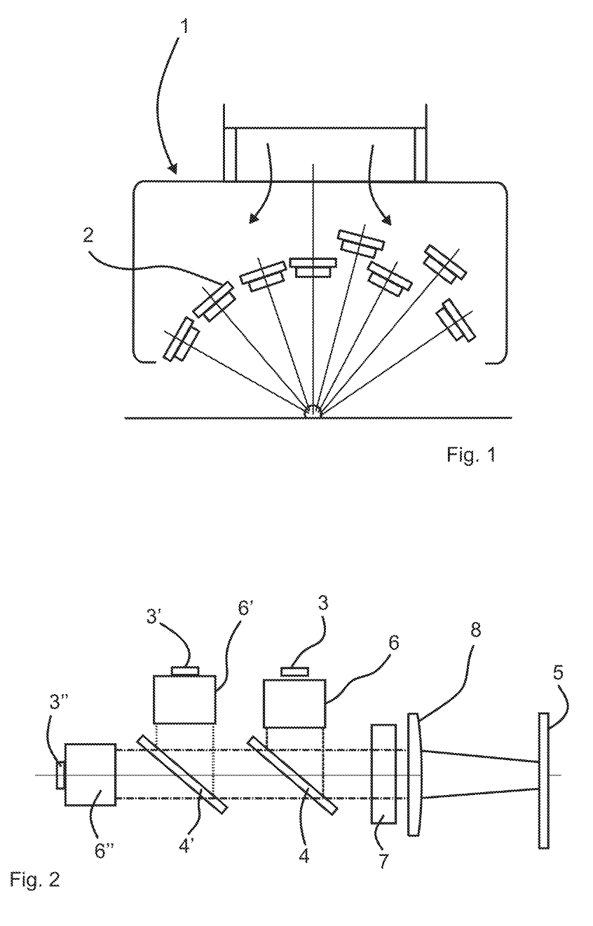

FIG. 1: a drying light source according to prior art;

FIG. 2: an optic arrangement of a drying light source in accordance with the invention;

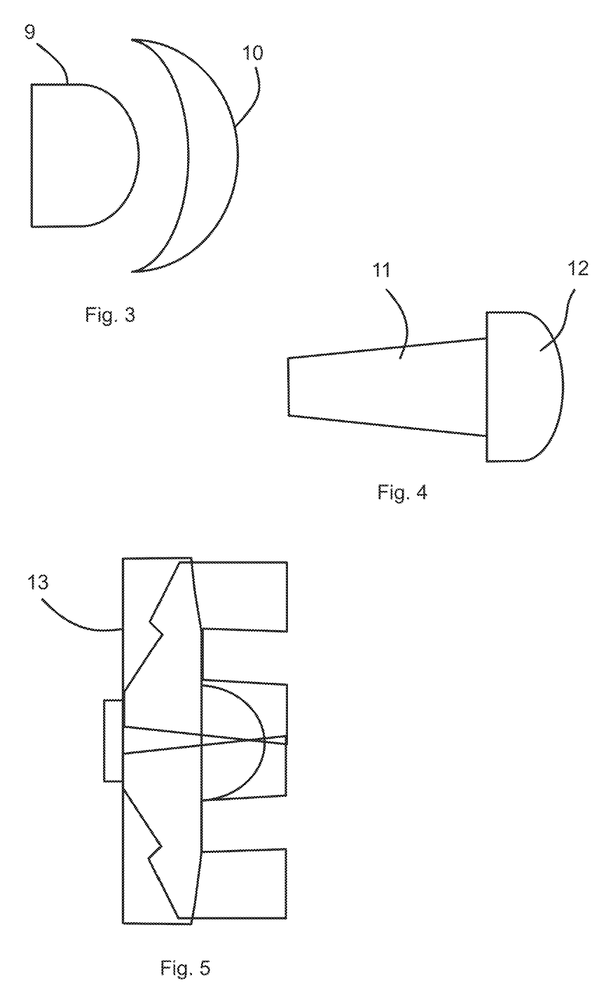

FIG. 3: condenser optics with spherical lenses:

FIG. 4: condenser optics with a lens and an optical fiber element;

FIG. 5: condenser optics with a suitably shaped reflector;

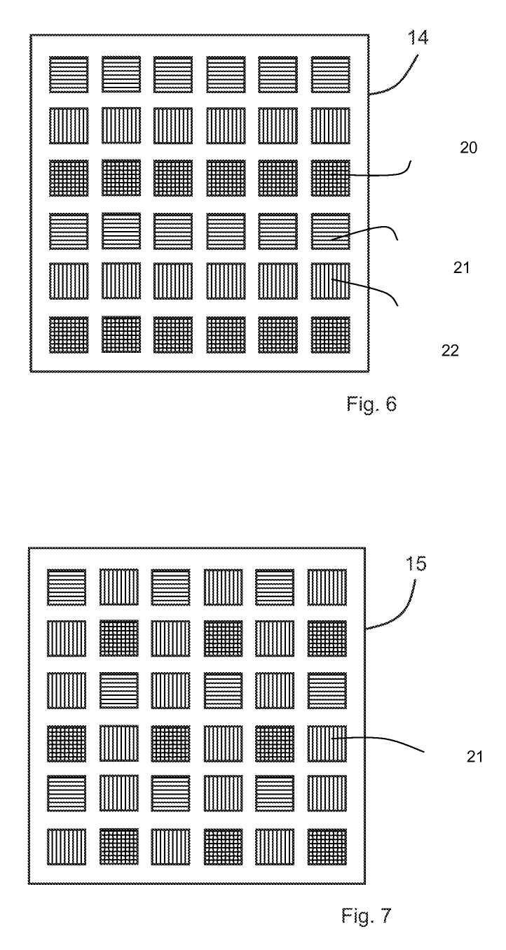

FIG. 6: an LED array with LEDs of different wave lengths;

FIG. 7: an LED array with dominant wave length;

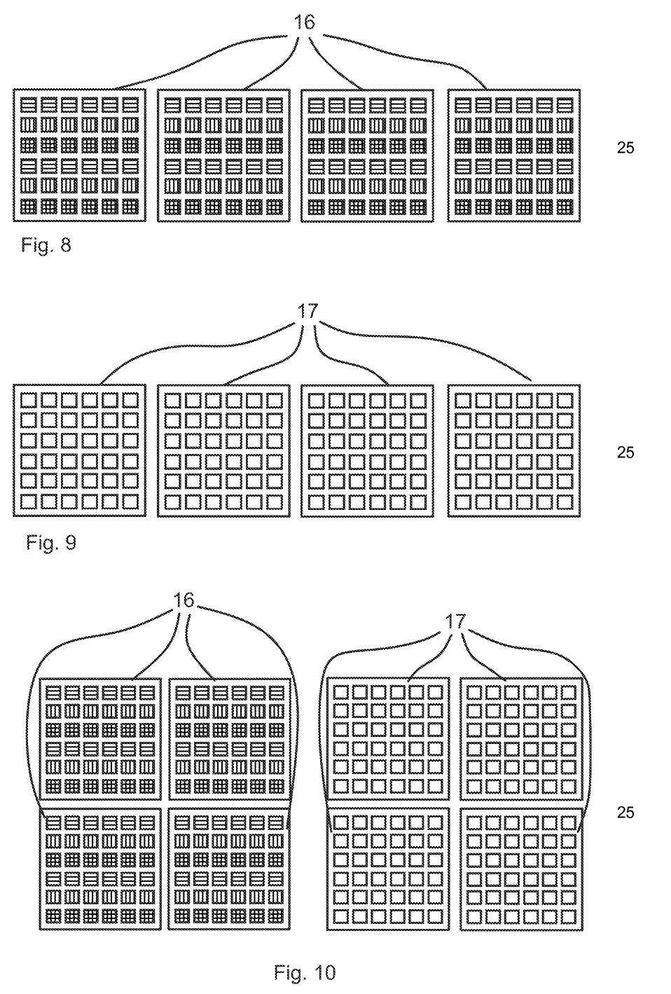

FIG. 8: a linear configuration of several LED arrays;

FIG. 9: a linear configuration of several LED arrays with the same spectral emission;

FIG. 10a), b): field-shaped configuration of several LED arrays;

FIG. 11: a cruciform configuration of several LED arrays;

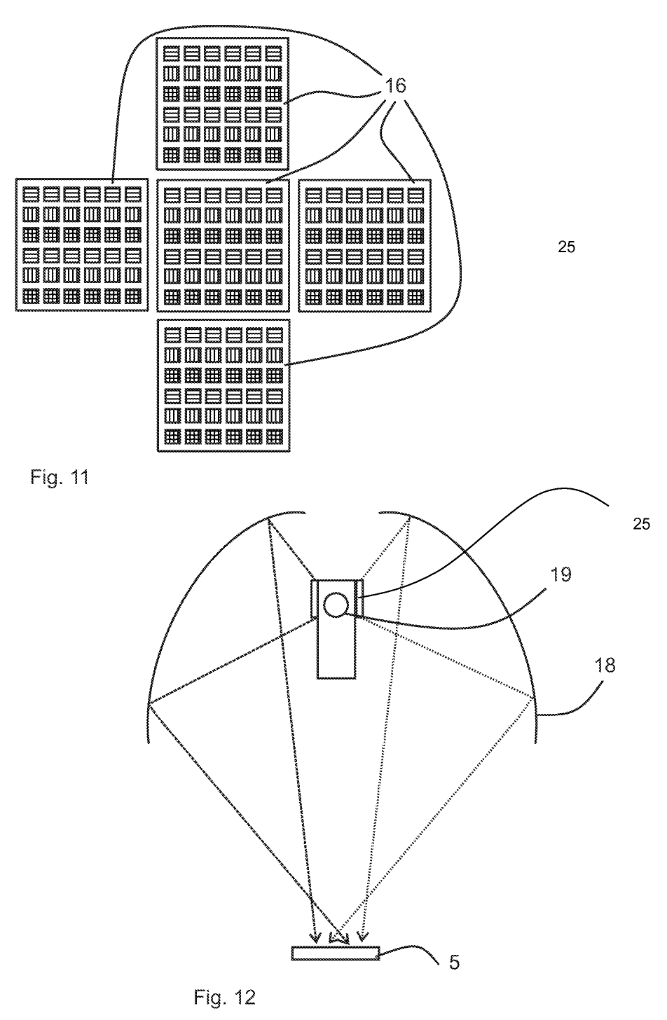

FIG. 12: a further optical configuration of a drying light source in accordance with the invention.

The configuration shown in FIG. 1 of a UV drying light source (1) is known from published patent application DE 10 2004 015 700 A1. Thereby, the individual LEDs (2) are configured in a housing in such a way, that their beams are jointly directed to an object zone. Because of the short distances to the object zone, and the undesired build-up of heat in the proximity of this object zone, cool air is circulated around the LEDs.

The configuration shown in FIG. 2 according to the present invention comprises individual light sources (3, 3′, 3″) with respectively one dominant wave length λ₁, λ₂, λ₃, for example, LEDs, halogen lamps, discharge lamps for the illumination of an object field (5). For line illumination, the individual light sources are located sequentially along a line. In accordance with the invention, this configuration comprises respectively pertaining condenser optics (6, 6′, 6″), a first (4) and a second (4′) beam divider, optics for the homogenization (7) of the converged light beam bundle and a collector (8). Thereby, the first beam divider (4) is designed strongly reflecting for light with a first wave length λ₁ and strongly permeable for light with a second wave λ₂ and light with a third wave length λ₃, while the beam divider (4′) is designed strongly reflecting for light with a second wave length λ₂ and strongly permeable for light with a third wave length λ₃. The optics for homogenization (7) of the heterodyne beam bundles can be realized with a micro lens array, with a spherical lens or an aspherical lens. The collector (8) can comprise an aspherical or an amorphous lens.

The arrangement in accordance with the invention can have cylindrical optics (for linear illumination) as well as also spherical optics (for punctiform or two-dimensional light sources). The possible wave lengths are in the range of UV to IR of the electro-magnetic spectrum. The superposition of light of several wave lengths with limited spectrum is possible. Thereby, the spectra can be separate from each other or overlap only sometimes.

The single light sources typically comprise high performance LEDs with large aperture emission, but they can also comprise classic illuminants such as, for example, halogen beams or gas discharge lamps.

FIGS. 3, 4 and 5 show suitable configurations for the condenser optics (6, 6′, 6″). Thereby, FIG. 3 shows a configuration with spherical lenses (9, 10), FIG. 4 a configuration with a fiber-optic element (11) with lens (12) and FIG. 5 a configuration with a specially molded optical element (13). This molded optical element (13) generates several differently guided bundles of rays from the same individual light source.

Thereby, the condenser optics (6, 6′, 6″) can be rotation-symmetric or linearly extended. For linear systems such as linear illumination, the linear extension can be realized by a sequential arrangement of individual optical elements as shown in 3, 4 and 5. When using such condenser optics (6, 6′, 6″) optics for the homogenization (7) of the heterodyned light beams and a collector (8) can also be dispensed with.

In order to achieve a high level of strength of irradiation onto the object area (5), the individual light sources (3, 3′, 3″) can also comprise LED arrays with n×n or m×n LED elements (chips). It is self-evident that the arrangement in accordance with the invention is thus suitable for the use of smaller LED elements, as well as also for use with larger LED arrays. For linear illumination, the LED elements or LED arrays can be configured sequentially along a line

FIG. 6 makes it clear that when using LED arrays, a uniform multi-wave lengths LED array (14) can be created, by configuring LED chips (20, 21, 22) with different wavelengths distributed in an array. Here, the red-luminous, green-luminous and blue-luminous LED chips are evenly distributed.

If a selected spectral range of the emitted light is to be dominant, the selection of the individual LED chips can be changed. For example, the dominant emission of green light can be achieved by using more green-luminescent LED chips (21) than those that have a different wave length. FIG. 7 shows such an LED array (15) with dominant spectral emission. It is self-evident that in place of red-luminescent, green-luminescent or blue-luminescent chips, different chips with other wave lengths can also be used, for example, with wave lengths in the deep blue spectrum and in the UV spectrum , for example, 365 nm, 385 nm and 395 nm. Typical values for the strength of LED high power diode arrays are:

365 nm>630 mW

405 nm>5.1 Watt

High power LED red >875 lumen

High power LED green>2,100 lumen

High power LED blue>400 lumen

High power LED white>800-1,000 lumen

FIG. 8 shows a linear illumination unit (25) for linear lamps in which the individual multi-wavelengths LEDs and/or multi-wavelengths LED arrays (16) are configured sequentially along a line. It is self-evident that linear illumination arrangements (25) with single wave lengths LED arrays (17), which, as is shown in FIG. 9, have only LEDs with the same wave length spectrum, can likewise be realized. The two illumination units (25) that are shown in FIGS. 10a) and b) represent field configurations of multiple wave length LED arrays (16), and/or single wave length LED arrays. A different embodiment is shown in FIG. 11. Here, the LED arrays (16) form an illumination configuration in the form of a cruciform field.

A further optical configuration for a drying light source in accordance with the invention has a reflector (18) in the light path between the LEDs and/or LED arrays and the object field (5). This reflector (18) can have an elliptical cross section or it can be shaped in the manner desired. Alternatively, individual LED arrays are mounted on a heat dissipating carrier element with or without a cooling channel (19).

The advantages of the present invention are directly obvious to the person skilled in the art and are to be seen in particular therein, that with the help of optical elements and if needed, with the aid of high power LEDs, a drying light source is provided that can easily be coordinated with the respective purpose of the application and use, which is powerful, has little tendency to be interference-prone, i.e. a drying light source that does not overheat itself.

1. Drying light source (1) for illuminating an object with at least one first individual illumination source (3) and a second individual light source (3′), whereby their emitted light respectively has a dominant wave length (λ₁, and/or λ₂), characterized by, that the optic means (6, 6′, 4, 4′) are provided for heterodyning the emitted light.

2. Drying light source (1) according to claim 1, characterized by, that the optic means comprise at least one reflector (18) and/or at least one beam divider (4), whereby the reflector (18) is mounted and designed in such a way that at least the emitted light (λ₁) of the first individual light source (3) is reflected and strikes heterodyned with the emitted light (λ₂) of the second individual light source (3′) onto the object field (5) that is to be illuminated, and whereby the beam divider is mounted and designed in such a way that the emitted light (λ₁) of the first light source (3) is reflected onto the object field (5) that is to be illuminated and the emitted light (λ₂) of the second individual light source (3′) can pass unhindered in order to heterodyne itself with the emitted light (λ₁) of the first light source (3).

3. Drying light source (1) according to claim 2, characterized by, that the individual illumination sources (LS1, LS2, LS3) are LEDs that have large aperture emission, halogen radiators or gas discharge lamps.

4. Drying light source (1) according to claim 3, characterized by, that the individual illumination sources (LS1, LS2, LS3) are provided with an optical condenser (CO1, CO2, CO3).

5. Drying light source (1) according to claim 3, characterized by, that a collector (8) is provided between the beam splitters (4, 4′) and the object field (5) that is to be illuminated.

6. Drying light source (1) according to claim 3, characterized by, that between the beam dividers (4, 4′) and the object field (5) that is to be illuminated, an optical means (7) is provided for the homogenization of the heterodyned irradiation.

7. Drying light source (1) according to claim 1, characterized by, that the optical means comprise cylindrical and/or spherical optical elements

8. Drying light source (1) according to claim 1, characterized by, that at least one of the light sources (3, 3′, 3″) comprises an illumination arrangement (25) with an LED array (14, 15, 16, 17) of n×n or m×n LEDs.

9. Drying light source (1) according to claim 8, characterized by, that the LED array (14, 15, 16, 17) has a number of similar or different LEDs (20, 21, 22).

10. Drying light source (1) according to claim 8, characterized by, that the illumination unit (25) has several LED arrays (14, 15, 16, 17).

11. Drying light source (1) according to claim 4, characterized by, that a collector (8) is provided between the beam splitters (4, 4′) and the object field (5) that is to be illuminated.

12. Drying light source (1) according to claim 4, characterized by, that between the beam dividers (4, 4′) and the object field (5) that is to be illuminated, an optical means (7) is provided for the homogenization of the heterodyned irradiation.

13. Drying light source (1) according to claim 5, characterized by, that between the beam dividers (4, 4′) and the object field (5) that is to be illuminated, an optical means (7) is provided for the homogenization of the heterodyned irradiation.
